(19) United States
(12) Patent Application Publication
(10) Pub. No.: US 2011/0315884 A1
(43) Pub. Date: Dec. 29, 2011

(54) COMPACT PET SCANNER

(76) Inventors: William A. Worstell, Wayland, MA (US); Paul Domigan, Andover, MA (US); Olof Johnson, Ashburnham, MA (US)

(21) Appl. No.: 12/737,879

(22) PCT Filed: Aug. 20, 2009
(86) PCT No.: PCT/US2009/054452

§ 371 Date: Sep. 7, 2011

Related U.S. Application Data
(60) Provisional application No. 61/091,588, filed on Aug. 25, 2008.

(51) Int. Cl. G01T 1/164; G01T 1/20

(52) U.S. Cl. 250/362; 250/363.03

(57) ABSTRACT

A nuclear imaging system including a PET scanner having a bore sized no larger than necessary to accommodate a human head; and a wheel-mounted scanner gantry for supporting the PET scanner, the wheel-mounted scanner gantry having a width small enough to fit through a standard doorway.

### FIELD OF DISCLOSURE

This disclosure relates to medical imaging, and in particular, to position emission tomography.

### BACKGROUND

In positron emission tomography (“PET”), a radioactive material is placed in the patient. In the process of radioactive decay, this material emits positrons. These positrons travel through the patient until they encounter electrons. When a positron and an electron meet, they annihilate each other. This results in emission of two gamma ray photons traveling in opposite directions. By detecting these gamma ray photons, one can infer the distribution of the radioactive material within the patient.

Known PET scanners are physically large structures that must be housed in large spaces. In addition, such PET scanners require specialized power sources.

To obtain high resolution images, it is typically necessary to use considerable quantities of radioactive material. While a patient may tolerate limited exposure to such quantities of radioactive material, repeated exposure is not desirable to the patient or to technicians operating the PET scanners.

### SUMMARY

The inventions described herein are based, inter alia, on the discovery that one can create a PET scanner that is small enough to be easily portable, but that nevertheless provides very high resolution and specificity using only minimal levels of radioactive tracers. These features permit the new PET scanners to be used for repeated neurological imaging of the same patient with minimal risk, thereby enabling longitudinal studies that, at higher doses, might be discouraged. The new features also enable the entire system to be moved easily from room to room or from patient to patient as required.

The large radial extent of a conventional PET scanner arises in part from an effort to overcome depth-of-interaction effects that would otherwise degrade the image. Such effects arise when a gamma ray emerging from the patient enters a scintillator block through a side face rather than from an end face of the scintillator block. The likelihood of this occurring decreases as the distance from the scintillator block to the patient increases. Thus, one way to avoid such image degradation, is to make the detector ring as large as possible. Conversely, if one were to make the detector ring smaller relative to the patient, degradation due to the depth-of-interaction would increase.

Although there exist “microPET” scanners that are physically small, these are used to scan correspondingly small animals. Thus, such microPET scanners do not address image degradation resulting from the depth-of-interaction effect.

To reduce dosage of radioactive material, PET scanners preferably capture as many gamma rays as possible. This could be achieved by providing a spherical PET scanner, which would then capture all gamma rays could be captured, regardless of the direction they take in leaving the patient. Such a scanner would be efficient, but difficult to build.

Another approach to capturing as many gamma rays as possible is to place the patient in a long cylinder. This permits capture of gamma rays that travel in a direction almost parallel to the cylinder's axis. In such cases, the longer the cylinder, the more efficiently the PET scanner will capture gamma rays. Although one could use a shorter cylinder, doing so would be expected to require increased dosage to maintain the same image quality. In one aspect, the invention features nuclear imaging systems including a PET scanner having a bore sized no larger than necessary to accommodate a human head; and a wheel-mounted scanner gantry for supporting the PET scanner, the wheel-mounted scanner gantry having a width small enough to fit through a standard doorway.

In another aspect, the invention features methods for imaging a patient with a PET scanner, the methods including: bringing the PET scanner to a room containing the patient; and inserting the patient's head in a bore of the PET scanner.

Another aspect of the invention features methods for powering a PET scanner, the methods including connecting the PET scanner to a 110 volt AC power source.

Yet another aspect of the invention features methods of imaging a patient with a PET scanner, the methods including injecting a radioactive material in the patient, the amount of radioactive material being selected to provide a radiation dose of no greater than 2 mCi.

In another aspect, the invention features methods of accumulating PET images in an image library, the methods including: deploying a plurality of PET scanners; from each PET scanner, receiving data representative of an image obtained from a patient; normalizing the data to conform to an image generated by a hypothetical NeuroPET scanner had the hypothetical NeuroPET scanner been used to scan the patient; and including the normalized data in the library of images.

Another aspect of the invention features methods of screening a population for a neurological disorder, the methods including: identifying members of the population having a pre-scan likelihood of the disorder, e.g., in excess of a predetermined value; performing a PET scan on each of the identified members; and as a result of the PET scan receiving data indicative of the likelihood of a specific biological condition being present in a given patient.

Another aspect of the invention features methods of differentially diagnosing patients suspected of having a specific neurologic disorder, the methods including: identifying members of the population having a pre-scan diagnosis of a more general class of neurological disorders of which a specific neurological disorder is a subclass; performing a PET scan on each of the generally diagnosed individuals; and as a result of the PET scan receiving data indicative of a more specific diagnosis in a given patient.

Another aspect of the invention features methods of monitoring the response of a neurological condition to a course of treatment including: identifying individuals who will be treated for a neurological condition either with a placebo or with an active agent or technique; performing a baseline PET scan on each such individual; administering the placebo or active agent or technique; one or more times performing a follow-up PET scan on each individual; and as a result of the PET scan receiving data indicative of the response of a specific biological condition to the treatment.

Another aspect of the invention features methods of pre-qualifying potential clinical trial participants, the methods including: identifying members of the population who have agreed to participate in a given clinical trial; performing a PET scan on each of said candidates; and receiving data as a result of the PET scan indicative of the likelihood of a specific biological condition being present in a given patient.

Another aspect of the invention features methods of identifying candidates for disease preventative treatments, the methods including: carrying out longitudinal PET studies of neurological disease onset and progression in initially asymptomatic, but at-risk individuals, either in the presence or absence of a disease-preventative treatment; identifying members of the population who are asymptomatic for a neurological disorder, but who are at risk for developing the disorder; performing a PET scan on each such individual; and receiving data as a result of the PET scan indicative of the likelihood that a given patient would benefit from disease-preventative treatment.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 is a schematic of the components of a compact PET scanner.

FIG. 2 is a schematic of a compact PET scanner arranged in a room for a scan.

FIG. 3 is a schematic of a system of compact PET scanners in data communication with a central PET server.

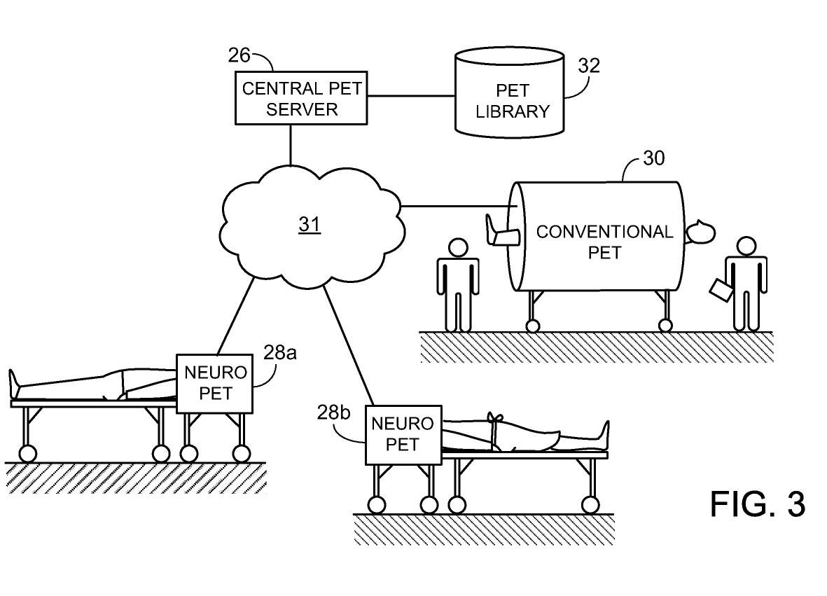

FIG. 4 is a schematic showing the alignment between a patient table and a compact PET scanner.

### DETAILED DESCRIPTION

The inventions described herein include new modular, small-scale PET systems that have three easily portable components: a scanner gantry, a patient table that locks into the scanner, and an operator console. The PET systems optionally include networking and database management protocols that allow a central operator console to communicate with one, dozens, or even hundreds of scanners and patient tables, as well as other operator consoles. The new PET systems are designed for imaging patients' brains, and thus can be used to diagnose and monitor a myriad of neurological conditions and disorders. In addition, the new systems' high resolution with low radiation exposure and compact design make them ideal for large-scale clinical studies, e.g., to select candidates to include in clinical trials for new drugs, for screening such new drug candidates, and for generating large patient databases for particular disorders.

### PET Scanner

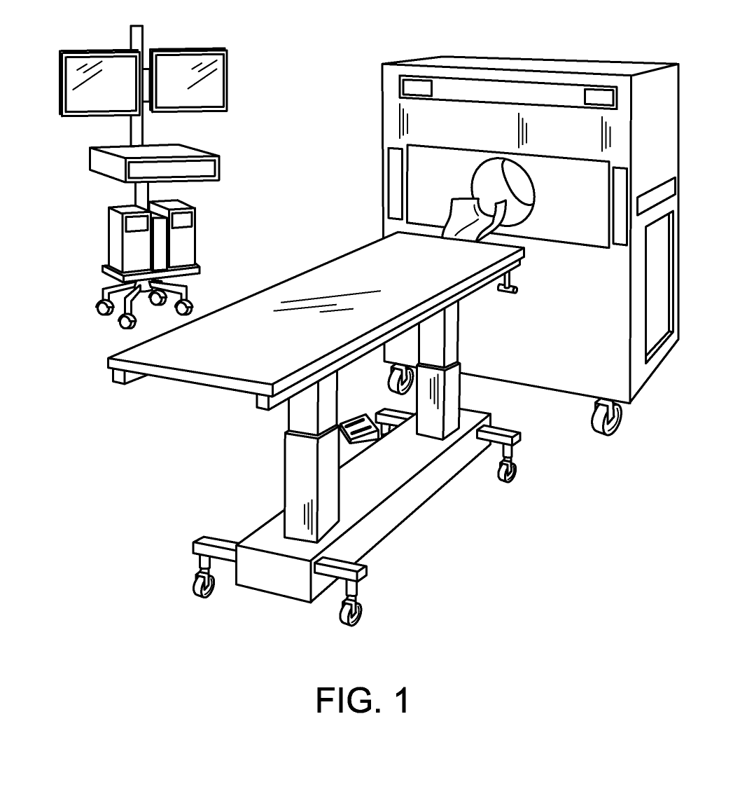

FIG. 1 shows a PET imaging system 10 that includes a PET scanner 12 having a bore 14 sized to accommodate a typical skull. A typical bore 14 for use with adult patients has a diameter of approximately 32 cm. Smaller bores can be used for pediatric applications. The PET scanner 12 has an axial length of only 24 centimeters and provides a transaxial field-of-view of 20 centimeters.

Since the PET scanner 12 has attributes that render it desirable for neurological imaging, it is referred to herein as a “NeuroPET” scanner. Similarly, the PET imaging system 10 will be referred to as a “NeuroPET” imaging system. However, the term “NeuroPET” is not intended to restrict the use of the device to imaging nerves or other neurological structures.

The illustrated NeuroPET scanner 12 uses much smaller doses of radioactive material to provide images with resolution comparable to, if not greater than, that provided by full size PET scanners having a 90 centimeter detector-ring diameter. The NeuroPET scanner 12 is thus suitable for scanning a subject multiple times for so called “longitudinal studies” in neurological and oncological applications. As discussed in further detail below, these features make the NeuroPET suitable for use in monitoring response to therapy, new drug trials, and longitudinal studies of disease progression and/or remission.

In one embodiment, the PET scanner 12 features an aperture of 318 mm, a height of 1575 mm, a width of 1168 mm, a depth of 889 mm, and a weight of 415 kg. The PET scanner 12 includes a universal power supply for supplying 3000 VA to gantry detectors and a gantry cluster.

The gantry detectors include detectors having an axial field-of-view of 247 mm and a transverse field-of-view of 200 nm. There are 7680 crystals, 192 photo-multiplier tubes, and 4 MAPMTs. The resulting NeuroPET scanner 12 features a spatial resolution of approximately 4.3 mm FWHM and sensitivity of 20 kcps/MBq. A typical FDG scan time is ten minutes using a typical FDG dose of less than 2 mCi.

The gantry cluster features 4 nodes, each with 2 processors, for a total of 8 CPUs. Each CPU is an AMD 2.2 GHz Dual Code Opteron processor. Each node also includes 500 GB of mirrored disk storage, for a total of 2 TB, and 8 GB DDR2 667 MHz RAM, for a total of 32 GB. The cluster operates using Red Hat Enterprise Linux 5 and communicates with other devices using a gigabit Ethernet LAN.

### Patient Table

The NeuroPET imaging system 10 further includes a patient table 16 that is powered for vertical movement, with an optional manual override. Movement into and out of the bore 14, i.e., horizontal movement, can be manual or can also be powered with a manual override. The patient table 16 features a detachable carbon-fiber headrest 15.

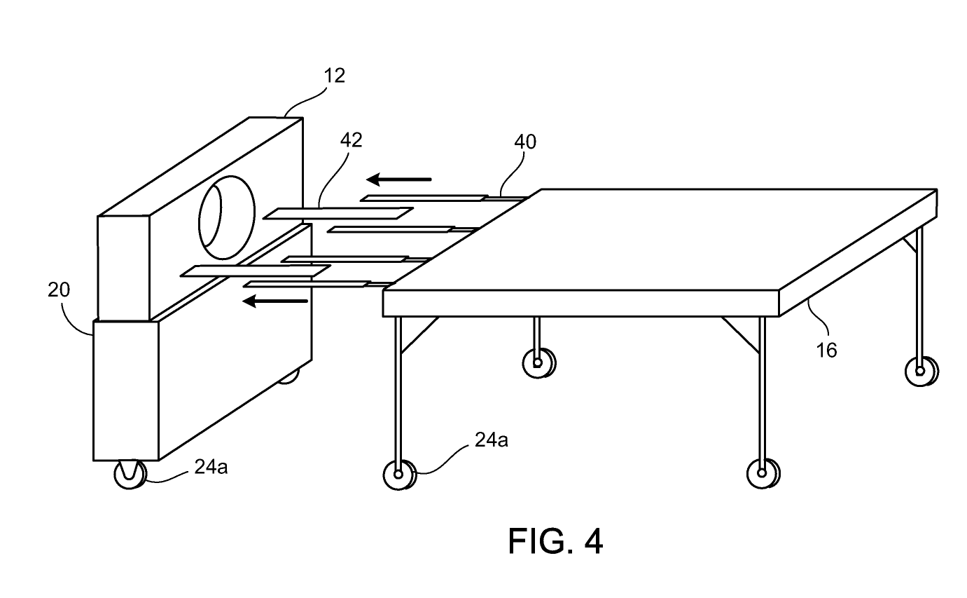

Referring to FIG. 4, the patient table 16 includes projecting structures 40 that extend axially for mating with corresponding rails 42 on the gantry 20. By aligning the patient table 16 and moving it toward the gantry 20 so that projecting structures 40 mate with corresponding rails 42, one can avoid errors in registration. This is particularly useful for longitudinal studies, where the relative positions of the patient and the scanner are expected to be the same at different, possibly widely separated times.

### Operator Console

The NeuroPET imaging system 10 further includes an operator console 18 for controlling the NeuroPET scanner 12. The operator console 18 includes at least one, and in some cases two displays 32. Suitable displays are LCD displays, however other display technologies can be used.

A console cluster within the operator console 18 uses a Windows XP Pro SP2 operating system executing on an Intel Core 2 Duo 3 GHz with 133 MHz FSB, 500 GB of storage, and 4 GB DDR2 1066 MHz RAM. To provide for archiving of data on a removable medium, the console cluster further includes an eSATA/USB/Firewire interface. A graphics card, such as a Radeon HD 2600XT PCI Express x16 graphics adapter with 512 MB GDDR3 provides a graphics display to a 30″ LCD monitor with a 1000:1 contrast ratio. A medical grade universal power supply provides 1000 VA at 120 V and 15 A to power the console cluster.

### Power Supplies

Both the operator console 18 and the NeuroPET scanner 12 are configured to draw no more than 20 amps from a 110 volt AC power source. As a result, the NeuroPET imaging system 10 can be used without any special power supply and is easily moved from room to room. The power demanded by the NeuroPET imaging system 10 is in fact so modest that it is practical to power it using a battery pack as well as an AC power source.

### Modularity

The NeuroPET imaging system 10 includes several features that are intended to facilitate transport and set-up.

For ease of transport, the NeuroPET scanner 12 is supported on a gantry 20, and the operator console 18 is supported on a rolling console cart 22. The gantry 20, patient table 16, and cart 22 all have wheels 24a-c or casters capable of swiveling 360 degrees. Preferably, the wheels 24a-c and/or casters can be locked into position prior to scan to ensure that no component of the NeuroPET system 10 moves during the scan itself.

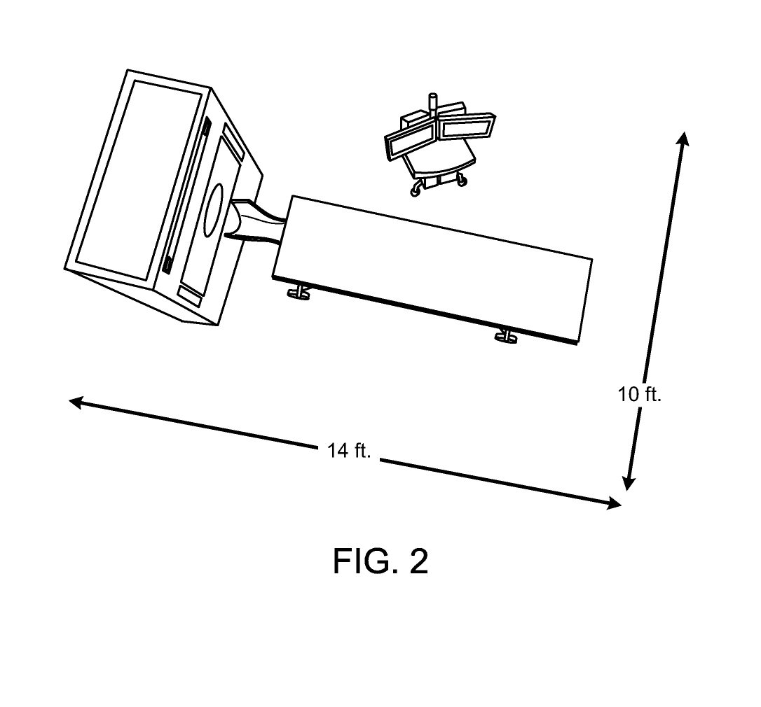

All components of the NeuroPET imaging system 10 are sized and shaped to be able to pass through a standard 36 inch wide standard doorway. The entire assembly can be configured for use in a room as small as 10×14 feet, as shown in FIG. 2.

As noted above, the patient table 16 and scanner 12 include an interlock mechanism to facilitate alignment and east the task of assembling the NeuroPET imaging system 10 for use.

The operator console 18 communicates with the NeuroPET scanner 12 over a local area network. In some embodiments, communication can be wireless. However in other embodiments a data communication cable connects the NeuroPET scanner 12 and the operator console 18. A suitable protocol for communication is a Gigabit Ethernet protocol. However, other protocols can also be used to effect such communication.

### Selected Applications

### Differential Diagnosis

Many disorders present similar symptoms. Differential diagnosis between such disorders relies in part on observing which of several physiological phenomena are causing such symptoms. For example, Alzheimer's Disease, Frontotemporal Dementia, Dementia with Lewy Bodies, and other neuropsychological disorders can present similar enough symptoms to make reliable diagnosis difficult, particularly in early stages of disease.

A NeuroPET imaging system 10 as described herein provides a low-cost and effective tool to assist in differential diagnosis of these and other disorders. The NeuroPET imaging system 10 is small enough to be used in clinical settings and inexpensive enough to be practical for use in connection with such differential diagnosis.

### Longitudinal Studies

A benefit of the illustrated NeuroPET imaging system 10 is its high sensitivity to gamma radiation. The high sensitivity ensures that the clinician and subject are exposed to only minimal doses of radioactive material. In some embodiments, these doses are as low as 2.0 mCi FDG, and even lower than 1.0 mCi. As a result, it is possible to perform repeated scans for longitudinal studies. In addition, each scan can be performed relatively quickly, e.g., in as little as ten minutes, thus reducing motion artifacts and enhancing the patient's comfort.

The low dosage required for a high-resolution imaging makes longitudinal studies of patients practical. Such longitudinal studies can be used to track the course of a disease or its remission, or to screen new drugs for treatment of such diseases.

### Population Studies

The illustrated NeuroPET imaging system 10 is also affordable to both purchase and operate. This reduces competition for scanner time and allows standardization across multiple separated sites.

In addition, the affordability of the illustrated NeuroPET imaging system 10 renders mass screening of a population eminently practical. Such mass screening can be used to detect early signs of Alzheimer's disease or other neurological disorders so that early intervention can be undertaken. The beneficial effect to the public health would be similar to, if not greater than, the public health benefit associated with the widespread use of colonoscopy in screening for colo-rectal cancers.

### Selecting Patients for Clinical Trials

In some cases, one would like to determine whether a newly-developed drug is useful for treating a particular disorder. This is often carried out by identifying patients who have the disorder, treating them with the drug, and observing the results. This procedure, which is often referred to as engaging in clinical trials, is most reliable when the patients actually have the correct disorder.

The task of identifying patients with the correct disorder is hampered when different disorders present similar symptoms. In such cases, it is often necessary to observe not just the symptom but the underlying cause of that symptom. One way to make such observations is to use a PET scanner.

Conventional PET scanners are often too costly or may be unavailable for use in identifying patients in a clinical trial. Moreover, the task of carrying out the scan can be so logistically difficult that it cannot practically be carried out in the numbers and at the locations used for clinical trials. The NeuroPET imaging system 10 as disclosed herein, however, is sufficiently low cost and can scan rapidly enough so that it can be used to identify patients for clinical trials.

### Screening New Drug Candidates

In many cases, one has several drugs that may or may not be effective for treating a particular disorder. To identify which of these candidate drugs is the most effective, one identifies patients who all suffer from the particular disorder and gives subsets of those patients different candidate drugs. Then, one observes which drug has corrected the cause of the disorder.

For some disorders, the symptoms of the disorder may disappear for reasons unrelated to the underlying physiological function that the drug is directed toward correcting. Or in other cases, there may be a significant delay between correction of the physiological function and a change in the symptoms presented by the patient. When this is the case, it is often difficult to assess whether a particular drug has been effective.

A NeuroPET imaging system 10 as described herein can be used to directly observe the underlying physiological phenomena that the drug is expected to treat. Moreover, because of its low cost, the speed at which it can provide results, and its logistical practicality, the NeuroPET imaging system 10 is a practical method for use in a large population to determine which of several candidate drugs is most effective for treating a particular condition.

### Generating Patient Databases

Yet another benefit is the NeuroPET imaging system's high spatial resolution. In some embodiments, the spatial resolution is less than approximately 5 mm. This high spatial resolution improves accuracy and detail of images. In addition, the similarity between the resolution obtained in a typical whole body PET/CT scanner and that obtained with the NeuroPET scanner 12 allows direct comparison between images obtained by the NeuroPET scanner 12 and images obtained by whole body PET/CT scanners. As a result, both types of images, when stored in a patient database, can be directly compared with each other.

Yet another advantage of the NeuroPET imaging system 10 lies in its large field-of-view. This large field of view enables one to avoid having to move the patient table 16 or gantry 20 during the scan. The ability to avoid such movement enhances the likelihood of proper patient registration.

Yet another advantage of the illustrated NeuroPET imaging system 10 is its portability and compact design. A NeuroPET imaging system 10 as disclosed herein provides flexibility in placement within a room and is easily movable between rooms. Accordingly, there is no need to renovate an existing facility for permanent installation, as is the case in conventional PET imaging systems. Moreover, the NeuroPET imaging system 10 can be brought to the patient, thus sparing the patient the inconvenience and discomfort of having to be transported to a whole-body PET scanner.

### OTHER EMBODIMENTS

In other embodiments, a central PET server 26 communicates with one or more NeuroPET imaging systems 28a, 28b at various locations within a hospital or other facility. Such a centralized PET server 26 can ensure that all NeuroPET imaging systems 10 throughout the hospital are operating according to some pre-selected quality standard. The same central PET server 26 can control multiple NeuroPET imaging systems and/or conventional PET systems 30 located in multiple hospitals or facilities across the country or around the globe.

A central PET server can also be used to accumulate a library or database 32 of images to be used for comparison with current images. Since the images would all have been taken by similar devices, calibration between images would be more robust and reliable. As time passes, such a library 32 of images would grow more reliable as more and more images are accumulated within it.

1. A nuclear imaging system comprising:
a PET scanner having a bore sized no larger than necessary to accommodate a human head; and
a wheel-mounted scanner gantry for supporting the PET scanner, the wheel-mounted scanner gantry having a width small enough to fit through a standard doorway.

2. A method for imaging a patient with a PET scanner, the method comprising:
bringing the PET scanner to a room containing the patient; and
inserting the patient's head in a bore of the PET scanner.

3. A method for powering a PET scanner, the method comprising connecting the PET scanner to a 110 volt AC power source.

4. A method of imaging a patient with a PET scanner, the method comprising injecting a radioactive material in the patient, the amount of radioactive material being selected to provide a radiation dose of no greater than 2 mCi.

5. A method of accumulating PET images in an image library, the method comprising:
deploying a plurality of NeuroPET scanners;
from each NeuroPET scanner
receiving data representative of an image obtained from a patient;
normalizing the data to conform to an image generated by a hypothetical NeuroPET scanner had the hypothetical NeuroPET scanner been used to scan the patient; and
including the normalized data in the library of images.

6. A method of screening a population for a neurological disorder, the method comprising:
identifying members of the population having a pre-test likelihood for having a condition in excess of a certain value;
performing a PET scan on each of said identified members; and
receiving data indicative of a result of the PET scan.

7. A method of differentially diagnosing patients suspected of having a specific neurologic disorder, the method comprising:
identifying members of the population having a pre-scan diagnosis of a more general class of neurological disorders of which a specific neurological disorder is a subclass;
performing a PET scan on each of said generally diagnosed individuals; and
as a result of the PET scan, receiving data indicative of a more specific diagnosis in a given patient.

8. A method of monitoring the response of a neurological condition to a course of treatment, the method comprising:
identifying individuals who will be treated for a neurological condition with at one of a placebo, an active agent, and a technique;
performing a baseline PET scan on each such individual;
treating the neurological condition by one of administering a placebo, administering an active agent, or executing a technique;
performing at least one follow-up PET scan on each individual; and
as a result of the at least one follow-up PET scan, receiving data indicative of the response of a specific biological condition to the treatment.

9. A method of pre-qualifying potential clinical trial participants, the method comprising:
identifying members of the population who have agreed to participate in a given clinical trial;
performing a PET scan on each of said candidates; and
receiving data as a result of the PET scan, the data being indicative of the likelihood of a specific biological condition being present in a given patient.

10. A method of identifying candidates for disease preventative treatments, the method comprising:
carrying out longitudinal PET studies of neurological disease onset and progression in initially asymptomatic but at risk individuals;
identifying members of the population who are asymptomatic for a neurological disorder but who are at risk for developing the disorder,
performing a PET scan on each such individual; and
receiving data as a result of the PET scan, the data being indicative of the likelihood that a given patient would benefit from disease-preventative treatment.
